(19) United States
(12) Patent Application Publication
(10) Pub. No.: US 2017/0188304 A1
(43) Pub. Date: Jun. 29, 2017

(54) Apparatuses and Methods for Cell Operation Signalling

(71) Applicant: Nokia Solutions and Networks Oy, Espoo (FI)

(72) Inventors: Timo Erkki LUNTTILA, Espoo (FI); Esa Tapani TIIROLA, Kempele (FI); Kari Juhani HOOLI, Oulu (FI)

(73) Assignee: Nokia Solutions and Networks OY, Espoo (FI)

(21) Appl. No.: 15/115,544

(22) PCT Filed: Jan. 31, 2014
(86) PCT No.: PCT/EP2014/051862

§ 371 Date: Jul. 29, 2016

(51) Int. Cl. H04W 52/02; H04W 52/14; H04W 52/16; H04W 52/24; H04W 52/32

(52) U.S. Cl. CPC H04W 52/0235; H04W 52/241; H04W 52/0274; H04W 52/325; H04W 52/16; H04W 52/146; H04W 52/143

(57) ABSTRACT

Apparatuses and methods for communication are provided. The solution includes receiving a message from a base station a user terminal is connected to. The message instructs the user terminal to search from a control channel transmitted by the base station an indicator. If the indicator is found, the user terminal operates according to a configuration where given downlink subframes are suspended. If the indicator is not found, the user terminal continues searching and assumes no change in downlink subframe transmission.

### FIELD

The exemplary and non-limiting embodiments of the invention relate generally to wireless communication systems. Embodiments of the invention relate especially to apparatuses, methods, and computer program products in communication networks.

### BACKGROUND

The following description of background art may include insights, discoveries, understandings or disclosures, or associations together with disclosures not known to the relevant art prior to the present invention but provided by the invention. Some of such contributions of the invention may be specifically pointed out below, whereas other such contributions of the invention will be apparent from their context.

Wireless communication systems are constantly under development. Developing systems provide a cost-effective support of high data rates and efficient resource utilization. One communication system under development is the 3rd Generation Partnership Project (3GPP) Long Term Evolution (LTE). An improved version of the Long Term Evolution radio access system is often called LTE-Advanced (LTE-A). The LTE is designed to support various services, such as high-speed data, multimedia unicast and multimedia broadcast services. LTE-A is under development and new releases are taken into use.

Typically, in a geographical area of a radio communication system there is provided a plurality of different kinds of radio cells as well as a plurality of radio cells. A radio system may be implemented as a multilayer network including several kinds of cells, such as macro-, micro- and picocells. Radio cells may be macro cells (or umbrella cells) which are large cells, usually having a diameter of up to tens of kilometres, or smaller cells such as micro, femto or pico cells. The smaller cells may be located within the coverage area of a larger macro cell. Typically, small cells are used to increase the capacity of the system in areas where the traffic density is high. The cooperation and resource usage of the cells must be planned carefully so that the capacity and quality of service of the system may be maximised.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to a more detailed description that is presented later.

According to an aspect of the present invention, there is provided an apparatus as claimed in claim 1.

According to an aspect of the present invention, there is provided an apparatus as claimed in claim 12.

According to an aspect of the present invention, there is provided a method as claimed in claim 19.

According to an aspect of the present invention, there is provided a method as claimed in claim 30.

According to an aspect of the present invention, there is provided a computer program embodied on a distribution medium as claimed in claim 37.

According to an aspect of the present invention, there is provided a computer program embodied on a distribution medium as claimed in claim 38.

### LIST OF DRAWINGS

Embodiments of the present invention are described below, by way of example only, with reference to the accompanying drawings, in which

FIG. 1 illustrates an example of a communication environment;

FIGS. 2 and 3 are flowcharts illustrating some embodiments of the invention;

FIG. 4 illustrates an example of ON/OFF-pattern; and

FIGS. 5 and 6 illustrate examples of apparatuses applying embodiments of the invention.

### DESCRIPTION SOME EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may also contain also features, structures, units, modules etc. that have not been specifically mentioned.

Embodiments are applicable to any base station, network element, user terminal (UT), user equipment (UE), server, corresponding component, and/or to any communication system or any combination of different communication systems that support required functionalities.

The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, embodiments.

Many different radio protocols to be used in communications systems exist. Some examples of different communication systems are the universal mobile telecommunications system (UMTS) radio access network (UTRAN or E-UTRAN), long term evolution (LTE®, known also as E-UTRA), long term evolution advanced (LTE-A®), Wireless Local Area Network (WLAN) based on IEEE 802.11 stardard, world-wide interoperability for microwave access (WiMAX), Bluetooth®, personal communications services (PCS) and systems using ultra-wideband (UWB) technology. IEEE refers to the Institute of Electrical and Electronics Engineers. LTE and LTE-A are developed by the Third Generation Partnership Project 3GPP.

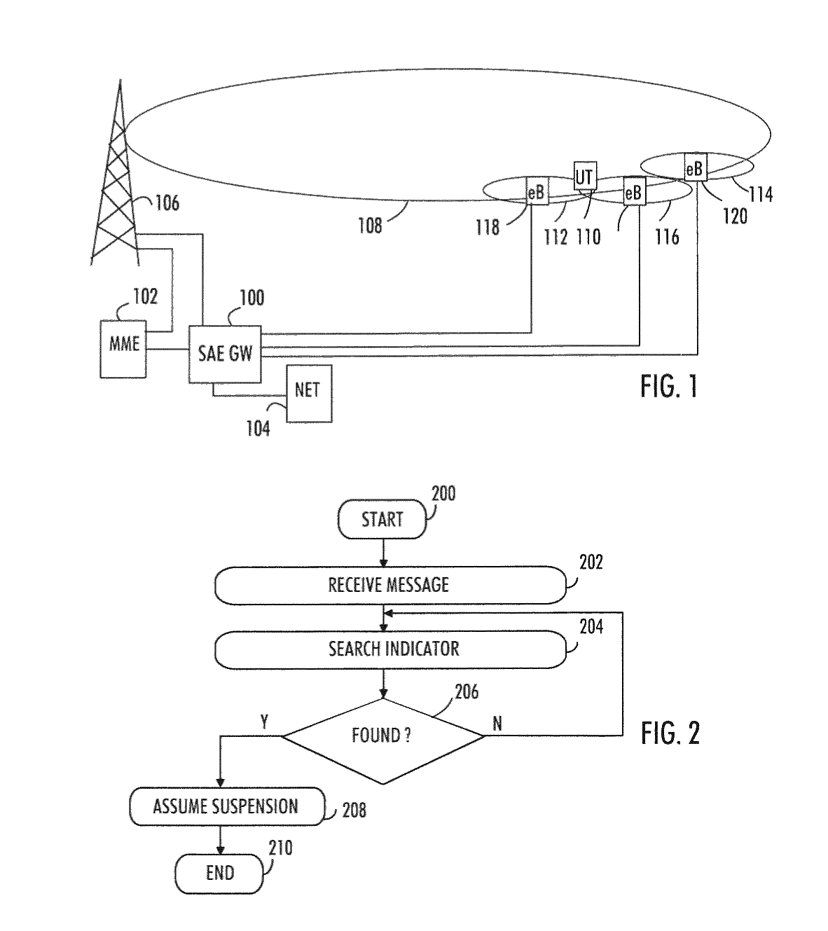

FIG. 1 illustrates a simplified view of a communication environment only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements and the protocols used in or for communication are irrelevant to the actual invention. Therefore, they need not to be discussed in more detail here.

In the example of FIG. 1, a radio system based on LTE/SAE (Long Term Evolution/System Architecture Evolution) network elements is shown. However, the embodiments described in these examples are not limited to the LTE/SAE radio systems but can also be implemented in other radio systems.

The simplified example of a network of FIG. 1 comprises a SAE Gateway (GW) 100 and an MME 102. The SAE Gateway 100 provides a connection to Internet (NET) 104. FIG. 1 shows a base station or an eNodeB 106 serving a cell 108. In this example, the eNodeB 106 is connected to the SAE Gateway 100 and the MME 102. In this example, the cell 108 is a macro cell and the eNodeB 106 is a macro cell node. The macro node 106 may be denoted as Macro eNodeB (MeNB).

In general, the eNodeBs (Enhanced node Bs) of a communication system may host the functions for Radio Resource Management: Radio Bearer Control, Radio Admission Control, Connection Mobility Control, Dynamic Resource Allocation (scheduling). The MME 102 (Mobility Management Entity) is responsible for the overall UT control in mobility, session/call and state management with assistance of the eNodeBs through which the UTs connect to the network. The SAE GW 100 is an entity configured to act as a gateway between the network and other parts of communication network such as the Internet for example. The SAE GW may be a combination of two gateways, a serving gateway (S-GW) and a packet data network gateway (P-GW).

The eNodeB 106 may provide radio coverage to a cell 108. The cell 108 may be of any size or form, depending on the antenna system utilized. The eNodeB 106 may control a cellular radio communication link established between the eNodeB 106 and terminal devices or user terminals (UT) 110 located within the cell 108.

The user terminal typically refers to a portable computing device that includes wireless mobile communication devices operating with or without a subscriber identification module (SIM), including, but not limited to, the following types of devices: a mobile station (mobile phone), smartphone, personal digital assistant (PDA), device using a wireless modem (alarm or measurement device, etc.), laptop and/or touch screen computer, tablet, game console, notebook, and multimedia device, or any other user terminal or equipment capable of communicating with the cellular communication network.

Further, although the apparatuses have been depicted as single entities, different units, processors and/or memory units (not all shown in FIG. 1) may be implemented.

In the example of FIG. 1, there are a set of small cells installed within the macro cell. The small cells may operate on the same carrier frequency as the macro cell (co-channel deployment). In another scenario small cells are operating on different carrier frequency compared to the macro cell layer. Each small cell is served by a node. As an example, small cells 112, 114, 116 served by nodes 118, 120 and 122 are illustrated. The nodes 118, 120, 122 serving small cells may be denoted as local area base stations or eNodeBs (LAeNB). In practice, the number of small cells may be considerable greater than three. The small cells may be connected to each other using an X2 interface, for example. Similar interface or interface of other type may also be between the macro eNodeB and a small cell eNodeB.

There may be situations when it would be beneficial to suspend some resources used by an eNodeB for a given period of time. This may be denoted as dynamic eNodeB discontinuous transmission (DTX) operation, where some resources are temporarily turned off. This may be beneficial especially in small cells.

Turning off eNodeB transmission for a short period of time may be useful for saving eNodeB energy and for reducing unnecessary interference from small cells when there is not downlink data to transmit by omitting the transmission of common signals when possible. However, cell discovery and handover issues must be taken into account.

On the other hand, in some systems, before being permitted to transmit, a user or an access point (such as eNodeB) may depending on the regulatory requirements need to monitor the given radio frequency for a short period of time to ensure the spectrum is not already occupied by some other transmission. This requirement is referred to as List-before-talk (LBT). The requirements for LBT vary depending on the geographic region: e.g. in the U.S. such requirements do not exist, whereas in e.g. Europe the network elements operating on unlicensed bands need to comply with LBT requirements.

User terminals operating in the cells where dynamic DXT is operated must be aware of the procedure. Therefore a reliable signaling solution supporting dynamic DTX is needed. In the past, the eNodeB may configure a discontinuous reception (DRX) pattern for the UT via higher layers, providing the UTs with a possibility to turn off the receiver when indicated. In the context of carrier aggregation, Medium Access Control (MAC) based component carrier activation/deactivation signaling can be used to tell the UT that it does not need to monitor downlink signals.

The problem with both abovementioned mechanisms is that they are quite semi-static by nature. Even with MAC activation/deactivation, the signaling and transition delays are in the order of tens of ms. This does not match well with dynamic small cell ON/OFF, where the target is to facilitate on/off on a per subframe basis. Another problem with the above listed methods is the signaling overhead: as both DRX and Component Carrier (CC) activation/deactivation signaling are UT specific, applying such signaling to all UTs in the cell becomes costly from downlink resource and energy consumption point of view.

In an embodiment, a signaling mechanism is provided to support dynamic small cell ON/OFF operation. The proposed signaling may be a Cell ON/OFF indicator. The proposed signaling may be applied in systems employing both TDD (Time Division Duplex) and FDD (Frequency Division Duplex).

FIG. 2 is a flowchart illustrating an embodiment of the invention. The example of FIG. 2 illustrates the operation of user terminal which is in connection with an eNodeB. The embodiment starts in step 200.

In step 202, the user terminal is configured to receive a message from the eNodeB.

In step 204, the user terminal is, on the basis of the message, configured to search from a control channel transmitted by the base station an indicator.

If the indicator is found in step 206, the user terminal is configured to in step 208 operate according to a configuration where predetermined downlink subframes are suspended. It thus assumes that the eNodeB suspends transmission on given downlink subframes.

If the indicator is not found in step 206, the user terminal is configured to continue searching and assume no change in downlink subframe transmission.

The process ends in step 210.

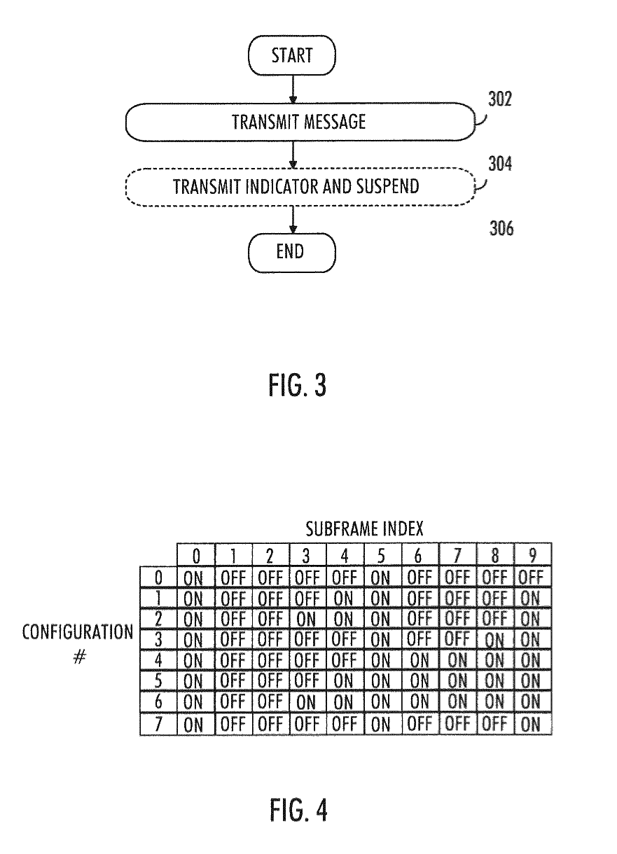

FIG. 3 is a flowchart illustrating an embodiment of the invention. The example of FIG. 3 illustrates the operation of an eNodeB.

In step 300, the eNodeB is configured to transmit a message to one or more user terminals the eNodeB is connected to, the message instructing the user terminals to search from a control channel transmitted by the eNodeB an indicator, and if the indicator is found, assume the eNodeB suspends transmission on given downlink subframes, and if the indicator is not found, continue searching and assume no change in downlink subframe transmission.

In an embodiment, the eNodeB is in step 302 configured to transmit the indicator and suspend transmission on given downlink subframes.

The process ends in step 304.

In an embodiment, the given subframes are predefined downlink subframes. The subframes may also subframes indicated in the indicator or configured in a higher layer.

The cell ON/OFF indicator can be considered as a group-common signal transmitted via downlink in DCI (Downlink Control Information). Thus basically the ON/OFF-indicator informs the UT the state of the cell the UT is camped on, i.e. whether the cell is ON or OFF according to predetermined rules.

In an embodiment, the indicator may relate to downlink subframes only: the UTs may assume that the eNodeB does not transmit anything during subframes that are switched OFF

Alternatively, the ON/OFF-switching may relate to both downlink and uplink subframes (or least some of uplink channels/signals) on the given serving cell.

In an embodiment, the UTs may suspend all uplink transmissions if “OFF” subframes are indicated. This may be a reasonable assumption especially in carrier aggregation operation when the cell applying dynamic on/off is a Secondary Cell.

Alternatively, only periodic uplink transmission (Channel State Information CSI, Sounding Reference Signal SRS) are suspended, but ACK/NACK, Scheduling Request SR, and Physical Random Access Channel PRACH transmission is still possible. In this case the eNodeB can receive these uplink signals also when switched OFF. This option may be more appropriate for a Primary Cell operation.

In an embodiment, uplink channels or transmission to be suspended in “OFF” subframes may be predefined or explicitly signaled e.g. via Radio Resource Control. They may also be linked to a “ON/OFF” pattern of subframes, where some “ON/OFF” patterns of subframes indicate that all uplink transmissions are suspended while other “ON/OFF” patterns of subframes indicate that only periodic uplink transmissions are suspended.

The uplink subframe used to transmit HARQ (hybrid automatic repeat request) feedback for PDSCH (Physical Downlink Shared Channel) may be determined according to normal TDD or FDD HARQ feedback timing. Alternatively, the “ON/OFF” pattern may be linked to a particular uplink—downlink configuration, referred to as the reference UL-DL configuration in the following. The reference UL-DL configuration determines the uplink subframes used for PDSCH HARQ feedback transmission according e.g. eIMTA reference configuration mechanism. The reference configuration may be predefined or explicitly signaled via RRC.

In an embodiment, in the downlink subframes indicated as OFF, the UT is not expected to monitor Enhanced Physical Downlink Control Channel EPDCCH and/or PDCCH. Channel State Information CSI measurement may also follow a specific procedure.

In another embodiment the available Cell ON/OFF indicator patterns for FDD may be derived from current TDD uplink/downlink configurations in a predefined way.

In an embodiment, the UTs may be configured to interpret the absence of Cell ON/OFF indicator so that the cell operates as without dynamic ON/OFF procedure, i.e. is ON in all the subframes of the at least one radio frame. This ensures that the eNodeB can convey dynamic signalling only on a per need basis. Overhead due to Cell ON/OFF indicator is not an issue—typically it's transmitted only when the cell load is extremely low.

In an embodiment, one or more following features may be used in connection with the ON/OFF indicator. A higher layer configured Radio Network Temporary Identifier (RNTI) may be used to scramble the cyclic redundancy check of the DCI carrying the ON/OFF indicator of a cell. The subframes which carry the DCI with the ON/OFF indicator of a cell may be pre-defined or higher layer configured. There may be a pre-defined or higher layer configured persistency window, which defines the time window when the predetermined ON/OFF configuration is applied. This may be e.g. equal to the periodicity of the ON/OFF indicator configuration. Alternatively, there can be multiple transmission opportunities defined for ON/OFF indicator within each persistency window. There may be pre-defined or higher layer configured latency involved in signaling the ON/OFF indicator, i.e. when the cell ON/OFF is applied. This may indicate that indicator received on the current persistency is valid only in the next persistency window.

The ON/OFF indicator of a cell may consist of a payload of 3 bits, for example. This numerical value is merely an example as the size of the indicator may vary depending on the system where it is applied. The size of the ON/OFF indicator may be aligned with DCI Format 1C. Another option is DCI format 1A. A single DCI may carry ON/OFF indication for multiple cells or transmission points.

In an embodiment, the dynamic ON/OFF signalling may be operated as follows. The eNodeB may configure the UTs to monitor the (Enhanced) Physical Downlink Control Channel PDCCH/EPDCCH for the ON/OFF indicator in a set of subframes by transmitting a message as described in step 300 above. As an example, the message may comprise:

the RNTI (denoted here as ON/OFF-RNTI) which is used to scramble the CRC of the DCI carrying reconfiguration message.

the periodicity as well as the subframe offsets determining when the ON/OFF indicator may be transmitted

The ON/OFF indicator may be transmitted in the common search space (CSS) in either the cell operating ON/OFF or its Primary Cell. Alternatively, it may be transmitted using other predetermined PDCCH/EPDCCH search space.

In an embodiment, TDD Enhanced Interference Mitigation & Traffic Adaptation (eIMTA) uplink-downlink reconfiguration signaling framework may be utilized to transmit the cell ON/OFF indicator both in an FDD and TDD network.

In an embodiment, when using TDD UL-DL-configurations to create ON/OFF patterns, the following principles can be applied:

| TDD eIMTA subframe type | FDD dynamic ON/OFF subframe type |
|---|---|
| Downlink subframe | ON |
| Special subframe | OFF |
| Uplink Subframe | OFF |

This results in the ON/OFF-pattern of FIG. 4 (corresponding to each TDD UL-DL configuration). The figure illustrates an example of seven subframe patterns or configurations having given subframes ON and given subframes OFF. For example, in pattern#0, subframes #0 and #5 are ON and subframes #2,#3,#4,#6,#7,#8 and #9 are OFF.

As mentioned, suspension of uplink channels may be linked to a “ON/OFF” pattern of subframes #0 to #7. For example, some “ON/OFF” patterns of subframes (such as #1, #3 and #6 for example) may indicate that all uplink transmissions are suspended while other “ON/OFF” patterns of subframes (such as #0, #1, #4, #5, #7, #8 and #9 for example) may indicate that only periodic uplink transmissions are suspended. The numeric values are merely illustrative examples.

In an embodiment in LTE based systems, downlink subframes #0 and #5 (which contain primary synchronization signal/secondary synchronization signal PSS/SSS and Physical Broadcast Channel PBCH) are not switched OFF but are always ON.

As mentioned, the proposed signaling and dynamic ON/OFF solution may be applied for both FDD and TDD. In the following we discuss examples of ON/OFF signalling in a TDD scenario In LTE based systems.

There are seven uplink-downlink configurations available. If 3-bit signaling is used for eIMTA there is one codepoint left unused. The unused codepoint can be used to indicate that predefined downlink or special subframes are switched off for a predefined time window. Alternatively, the eNodeB may configure subframes subject to dynamic ON/OFF switching explicitly via RRC, or they can be predefined.

In an embodiment, the eNodeB may configure the UT to interpret a single or some of uplink-downlink configurations as ON/OFF pattern(s). The uplink-downlink configurations to be interpreted as ON/OFF patterns can be explicitly signaled via RRC or they can be predefined. Also the actual ON/OFF patterns can be explicitly signalled via RRC, or they can be predefined, as discussed above.

In an embodiment, the eNodeB can use ON/OFF signaling with ON/OFF RNTI and eIMTA uplink-downlink reconfiguration signaling in parallel by allocating different RNTI for eIMTA UL-DL reconfiguration signaling.

The last two examples are good options if more uplink-downlink configurations are defined so that there does not remain any unused codepoints left in the corresponding signaling field.

In an embodiment, the eNodeB has full flexibility to switch the cell ON “on the fly” even if dynamic signalling transmitted by the eNodeB indicates that cell is being switched OFF. This is beneficial especially when long cell ON/OFF persistency windows (such as 40 ms or 80 ms, for example) are used.

Let us study two examples, first the arrival of uplink UL data while ON/OFF suspension is in effect. If a UT determines it has data to transmit it may transmit on configured SR or PRACH resources once data arrives to its uplink buffer (if those channels are not suspended). The eNodeB may respond to the uplink transmission with uplink grant transmitted on downlink “ON” subframe. Once the UT receives the uplink grant, the UT considers the cell to be turned “ON” and resumes SRS transmissions as well as PDCCH/EPDCCH monitoring in all downlink subframes.

In the case of the arrival of downlink data while OFF suspension is in effect, the UT may receive PDSCH assignment on a downlink “ON” subframe. In that case, the UT resumes CSI reporting and monitors PDCCH/EPDCCH also on the next dowlink “OFF” subframe/subframes. In an embodiment, there may be an OFF-timer of a given number of subframes, set upon reception of the downlink data in an ON-subframe and decremented in each OFF subframe unless further downlink data is received. If the UT receives a valid PDSCH assignment in downlink “OFF” subframe/subframes, the UT considers the cell to be turned “ON” and continues the PDCCH/EPDCCH monitoring in all downlink subframes.

After a predefined or configured period of inactivity, the UT may return to cell OFF state as indicated by the Cell ON/OFF indicator. In an embodiment, this would mean that once the UT has not received any uplink grant/PHICH for a period of inactivity, it will suspend SRS transmissions (if so configured). Further, once the UT has not received any downlink grant in “OFF” subframes for a period of inactivity, it will suspend PDCCH/EPDCCH monitoring in “OFF” subframes. Further, once the UT has not received any downlink grant for a period of inactivity, it will suspend CSI transmissions (if so configured).

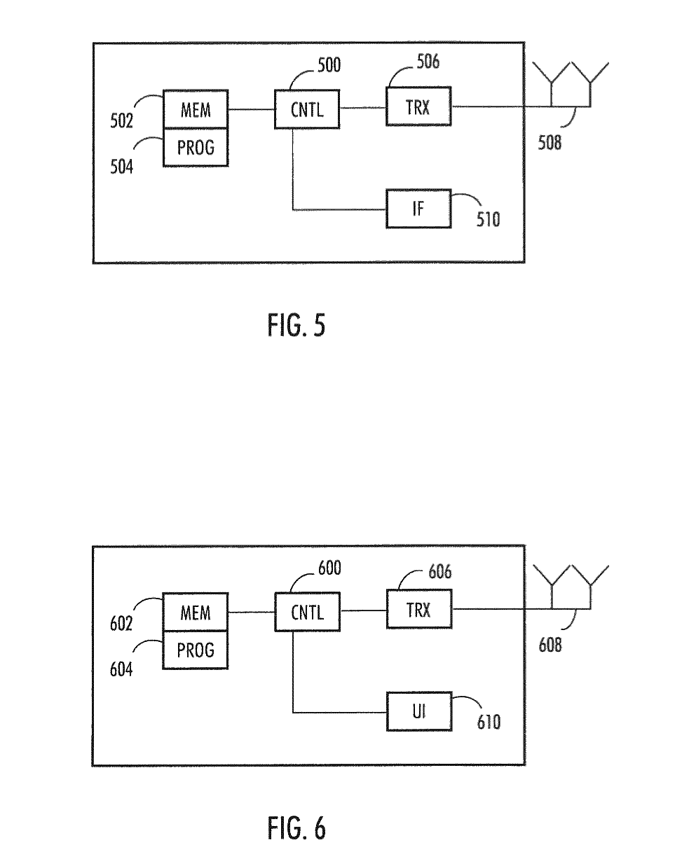

FIG. 5 illustrates an embodiment. The figure illustrates a simplified example of an apparatus in which embodiments of the invention may be applied. In some embodiments, the apparatus may be a base station or eNodeB or a part of an eNodeB.

It should be understood that the apparatus is depicted herein as an example illustrating some embodiments. It is apparent to a person skilled in the art that the apparatus may also comprise other functions and/or structures and not all described functions and structures are required. Although the apparatus has been depicted as one entity, different modules and memory may be implemented in one or more physical or logical entities.

The apparatus of the example includes a control circuitry 500 configured to control at least part of the operation of the apparatus.

The apparatus may comprise a memory 502 for storing data. Furthermore the memory may store software 504 executable by the control circuitry 500. The memory may be integrated in the control circuitry.

The apparatus comprises a transceiver 506. The transceiver is operationally connected to the control circuitry 500. It may be connected to an antenna arrangement 508 comprising one more antenna elements or antennas.

The software 504 may comprise a computer program comprising program code means adapted to cause the control circuitry 500 of the apparatus to control the transceiver 506.

The apparatus may further comprise an interface 510 operationally connected to the control circuitry 500. The interface may connect the apparatus to other respective apparatuses such as eNodeBs via X2 interface or to the core network.

The control circuitry 500 is configured to execute one or more applications. The applications may be stored in the memory 502.

In an embodiment, the applications may cause the apparatus to transmit a message to one or more user terminals the apparatus is connected to, the message instructing the user terminals to search from a control channel transmitted by the apparatus an indicator, and if the indicator is found, assume the apparatus suspends transmission on given downlink subframes, and if the indicator is not found, continue searching and assume no change in downlink subframe transmission.

FIG. 6 illustrates an embodiment. The figure illustrates a simplified example of an apparatus in which embodiments of the invention may be applied. In some embodiments, the apparatus may be user terminal, user equipment or a part of user equipment.

It should be understood that the apparatus is depicted herein as an example illustrating some embodiments. It is apparent to a person skilled in the art that the apparatus may also comprise other functions and/or structures and not all described functions and structures are required. Although the apparatus has been depicted as one entity, different modules and memory may be implemented in one or more physical or logical entities.

The apparatus of the example includes a control circuitry 600 configured to control at least part of the operation of the apparatus.

The apparatus may comprise a memory 602 for storing data. Furthermore the memory may store software 604 executable by the control circuitry 600. The memory may be integrated in the control circuitry.

The apparatus comprises a transceiver 606. The transceiver is operationally connected to the control circuitry 600. It may be connected to an antenna arrangement 608 comprising one more antenna elements or antennas.

The software 604 may comprise a computer program comprising program code means adapted to cause the control circuitry 600 of the apparatus to control the transceiver 606.

The apparatus may further comprise user interface 610 operationally connected to the control circuitry 600. The user interface may comprise a display which may be touch sensitive, a keyboard, a microphone and a speaker, for example.

The control circuitry 600 is configured to execute one or more applications. The applications may be stored in the memory 602.

In an embodiment, the applications may cause the apparatus to message instructing the apparatus to search from a control channel transmitted by the base station an indicator, and if the indicator is found, assume the base station suspends transmission on given downlink subframes, and if the indicator is not found, continue searching and assume no change in downlink subframe transmission.

The steps and related functions described in the above and attached figures are in no absolute chronological order, and some of the steps may be performed simultaneously or in an order differing from the given one. Other functions can also be executed between the steps or within the steps. Some of the steps can also be left out or replaced with a corresponding step.

The apparatuses or controllers able to perform the above-described steps may be implemented as an electronic digital computer, or a circuitry which may comprise a working memory (RAM), a central processing unit (CPU), and a system clock. The CPU may comprise a set of registers, an arithmetic logic unit, and a controller. The controller or the circuitry is controlled by a sequence of program instructions transferred to the CPU from the RAM. The controller may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

An embodiment provides a computer program embodied on a distribution medium, comprising program instructions which, when loaded into an electronic apparatus, are configured to control the apparatus to execute the embodiments described above.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. Depending on the processing power needed, the computer program may be executed in a single electronic digital computer or it may be distributed amongst a number of computers.

An embodiment provides an apparatus, comprising means for receiving a message from a base station the apparatus is connected to, the message instructing the apparatus to searching from a control channel transmitted by the base station an indicator, and if the indicator is found, operate according to a configuration where given downlink subframes are suspended, and if the indicator is not found, continue searching and assume no change in downlink subframe transmission.

An embodiment provides an apparatus, comprising means for transmitting a message to one or more user terminals the apparatus is connected to, the message instructing the user terminals to search from a control channel transmitted by the apparatus an indicator, and if the indicator is found, assume the apparatus suspends transmission on given downlink subframes, and if the indicator is not found, continue searching and assume no change in downlink subframe transmission.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

It will be obvious to a person skilled in the art that, as the technology advances, the inventive concept can be implemented in various ways. The invention and its embodiments are not limited to the examples described above but may vary within the scope of the claims.

1. An apparatus, comprising:
at least one processor; and
at least one memory including computer program code,
the at least one memory and the computer program code configured to, with the at least one processor, cause the apparatus at least to:
receive a message from a base station the apparatus is connected to, the message instructing the apparatus to search from a control channel transmitted by the base station for an indicator, and if the indicator is found, operate according to a configuration where given downlink subframes are suspended, and if the indicator is not found, continue searching and assume no change in downlink subframe transmission; and
perform the searching from the control channel transmitted by the base station for the indicator, and in response to the indicator being found, operating according to the configuration where given downlink subframes are suspended, and in response to the indicator not being found, continue searching and assume no change in downlink subframe transmission.

2.-11. (canceled)

12. An apparatus, comprising:
at least one processor; and
at least one memory including computer program code,
the at least one memory and the computer program code configured to, with the at least one processor, cause the apparatus at least to:
transmit a message to one or more user terminals the apparatus is connected to, the message instructing the user terminals to search from a control channel transmitted by the apparatus for an indicator, and if the indicator is found, assume the apparatus suspends transmission on given downlink subframes, and if the indicator is not found, continue searching and assume no change in downlink subframe transmission;
suspending, in response to sending the indicator, transmission on the given downlink subframes; and
performing, in response to not sending the indicator, no change in downlink subframe transmission.

13.-18. (canceled)

19. A method, comprising:
receiving a message from a base station the apparatus is connected to, the message instructing the apparatus to perform searching from a control channel transmitted by the base station for an indicator, and if the indicator is found, operating according to a configuration where given downlink subframes are suspended, and if the indicator is not found, continue searching and assume no change in downlink subframe transmission; and
performing the searching from the control channel transmitted by the base station for the indicator, and in response to the indicator being found, operating according to the configuration where given downlink subframes are suspended, and in response to the indicator not being found, continue searching and assume no change in downlink subframe transmission.

20. The method of claim 19, wherein the given subframes are predefined subframes or subframes indicated in the indicator.

21. The method of claim 19, further comprising: suspending periodic uplink transmissions if the indicator is found.

22. The method of claim 19, further comprising: suspending uplink transmissions which are predefined or indicated in the indicator.

23. (canceled)

24. The method of claim 19, further comprising, if the indicator is found, suspending monitoring downlink control channels and/or measurements from reference signals in suspended subframes.

25. The method of claim 19, further comprising, if the indicator is found,
determining there is data to transmit;
transmitting a request to transmit;
receiving uplink grant on a control channel transmitted on a subframe not suspended;
determining suspension of subframes is terminated and/or resuming periodic uplink transmissions and control channel monitoring of all subframes.

26. The method of claim 19, further comprising:
receiving on a control channel a downlink resource assignment on a not suspended subframe;
resuming control channel monitoring and channel state reporting on a given number of next subframes indicated suspended.

27. The method of claim 26, further comprising: suspending periodic uplink transmissions and/or control channel monitoring of the subframes after monitoring a given number of suspended subframes without detecting transmissions.

28. The method of claim 19, further comprising:
receiving on a control channel a downlink resource assignment on a suspended subframe;
determining suspension of subframes is terminated and/or resume periodic uplink transmissions and control channel monitoring of all subframes.

29. The method of claim 19, further comprising: receiving via Radio Resource Control signalling a message that suspension of sub-frames is terminated.

30. A method, comprising:
transmitting from an apparatus a message to one or more user terminals the apparatus is connected to, the message instructing the user terminals to search from a control channel transmitted by the apparatus for an indicator, and if the indicator is found, assume the apparatus suspends transmission on given downlink subframes, and if the indicator is not found, continue searching and assume no change in downlink subframe transmission;
suspending, in response to sending the indicator and by the apparatus, transmission on the given downlink subframes; and
performing, in response to not sending the indicator and by the apparatus, no change in downlink subframe transmission.

31. The method of claim 30, further comprising: transmitting the indicator and suspending transmission on given downlink subframes.

32. The method of claim 30, wherein the given subframes are predefined subframes or subframes indicated in the indicator.

33. (canceled)

34. The method of claim 30, further comprising: transmitting the indicator in predefined downlink subframes.

35. The method of claim 30, wherein the subframes are suspended for a duration which either predetermined or indicated in the indicator.

36. The method of claim 30, wherein the indicator further instructs the user terminals to suspend uplink transmissions which are predefined or indicated in the indicator.

37. A computer program embodied on a non-transitory distribution medium, comprising program instructions which, when loaded into an electronic apparatus, are configured to control the apparatus to execute the method of claim 19.

38. A computer program embodied on a non-transitory distribution medium, comprising program instructions which, when loaded into an electronic apparatus, are configured to control the apparatus to execute the method of claim 30.
